(19) United States
(12) Patent Application Publication
(10) Pub. No.: US 2026/0235838 A1
(43) Pub. Date: Aug. 13, 2026

(54) ADAPTER PANEL FOR AN OUTDOOR FIBER DISTRIBUTION CLOSURE AND RELATED ASSEMBLIES

(71) Applicant: OUTDOOR WIRELESS NETWORKS LLC, Richardson, TX (US)

(72) Inventors: Peter C. AUGDAHL, Richfield, MI (US); Oscar F. BRAN DE LEÓN, Yuma, AZ (US); Thomas B. MARCOUILLER, Shakopee, MI (US)

(21) Appl. No.: 19/153,411

(22) PCT Filed: Feb. 1, 2024
(86) PCT No.: PCT/US2024/013916

§ 371 Date: Aug. 4, 2025

Related U.S. Application Data
(60) Provisional application No. 63/485,292, filed on Feb. 16, 2023.
(60) Provisional application No. 63/492,839, filed on Mar. 29, 2023.

(51) Int. Cl. G02B 6/44

(52) U.S. Cl. CPC G02B 6/44528; G02B 6/44465; G02B 6/4447; G02B 6/44515

(57) ABSTRACT

The present application is directed to an adapter panel for a fiber management system. The adapter panel includes a base, a cable retention section, a plurality of columns, and a cable routing section. The base is configured to be secured to a base member of an outdoor fiber distribution closure. The cable retention section is coupled to the base via one or more extension members, and has a main body including a pair of channels, the channels being configured to guide and provide support to a respective fiber optic trunk cable being routed into the outdoor fiber distribution closure, and a pair of flange members extending outwardly from opposing ends of the main body, each flange member including a securing feature configured to engage with a respective lock pin which are configured to engage a gel block. The plurality of columns extend upwardly from the base and configured to secure a plurality of fiber optic connector adapters thereto, the plurality of columns being also configured to support and hold the plurality of fiber optic connector adapters a distance above the base of the adapter panel. The cable routing section including a pair of arcuate members and a routing tower coupled to and extending upwardly from the base, the arcuate members being configured such that excess cable of one or more fiber optic breakout cables separated from the fiber optic trunk cable can be wound around the arcuate members without exceeding a minimum bend radius of the one or more fiber optic breakout cables and the routing tower being configured to guide the one or more fiber optic breakout cables toward the fiber optic connector adapters for connection. Fiber management system assemblies are also described herein.

### RELATED APPLICATIONS

The present application claims priority from and the benefit of U.S. Provisional Patent Application No. 63/485,292, filed Feb. 16, 2023, and 63/492,839, filed Mar. 29, 2023, the disclosures of which are hereby incorporated herein by reference in full.

### FIELD

The present invention is directed generally to fiber management systems, and in particular, to an adapter panel for an outdoor fiber distribution closure and related assemblies.

### BACKGROUND

Current environmentally sealed closures for fiber management systems provide the function of splicing, patching, and passive component integration in an external network. The conventional optical fiber splice closure generally comprises a base and a cover, for example, the base and the cover each may be an intergraded molded piece. The inner space of the closure often is divided into a plurality of different operation areas, such as a splice fiber connection area, a main fiber splicing area, and a redundant fiber winding area. It may be desirable if these existing fiber management system closures could be repurposed for different applications, such as Fiber to the Antenna (FTTA) applications.

### SUMMARY

A first aspect of the present invention is directed to a fiber management system assembly. The assembly includes a closure and an adapter panel. The closure has a base member and a cover which together define an interior cavity. The base member and cover are configured to be secured together in a closed and locked position via one or more locking features. The adapter panel includes a base configured to be secured to the base member of the closure, a cable retention section coupled to the base via one or more extension members, the cable retention section configured to secure a gel block within the interior cavity of the closure, a plurality of columns extending upwardly from the base, the plurality of columns configured to secure a plurality of fiber optic connector adapters within interior cavity of the closure, and a cable routing section configured to organize and route one or more fiber optic breakout cables to the plurality of fiber optic connector adapters.

Another aspect of the present invention is directed to an adapter panel for a fiber management system. The adapter panel includes a base, a cable retention section, a plurality of columns, and a cable routing section. The base is configured to be secured to a base member of an outdoor fiber distribution closure. The cable retention section is coupled to the base via one or more extension members, has a main body including a pair of channels, the channels being configured to guide and provide support to a respective fiber optic trunk cable being routed into the outdoor fiber distribution closure, and a pair of flange members extending outwardly from opposing ends of the main body, each flange member including a securing feature configured to engage with a respective lock pin which is configured to engage a gel block. The plurality of columns extend upwardly from the base and configured to secure a plurality of fiber optic connector adapters thereto, the plurality of columns being also configured to support and hold the plurality of fiber optic connector adapters a distance above the base of the adapter panel. The cable routing section includes a pair of arcuate members and a routing tower coupled to and extending upwardly from the base, the arcuate members are configured such that excess cable of one or more fiber optic breakout cables separated from the fiber optic trunk cable can be wound around the arcuate members without exceeding a minimum bend radius of the one or more fiber optic breakout cables and the routing tower is configured to guide the one or more fiber optic breakout cables toward the fiber optic connector adapters for connection.

Another aspect of the present invention is directed to a fiber management system assembly. The assembly includes at least one fiber optic trunk cable having one or more fiber optic breakout cables, a plurality of fiber optic jumper cables, a gel block, a plurality of fiber optic connector adapters, a closure including a base member and a cover which together define an interior cavity, and an adapter panel. The gel block includes a plurality of openings proximate to a lower portion of the gel block and a plurality of recesses proximate to an upper portion of the gel block, and the at least one fiber optic trunk cable is received through a respective opening in the gel block and at least one of the plurality of fiber optic jumper cables is received through a respective recess in the gel block. The adapter panel includes a base configured to be secured to the base member of the closure, a cable retention section coupled to the base, the cable retention section has main body including a pair of channels configured to guide and provide support to the at least one fiber optic trunk cable, and a pair of flange members extending outwardly from opposing ends of the main body, each flange member having a securing feature configured to engage the gel block, a plurality of columns extending upwardly from the base, the plurality of columns configured to secure the plurality of fiber optic connector adapters thereto and to support and hold the plurality of fiber optic connector adapters a distance above the base of the adapter panel, and a cable routing section having a pair of arcuate members and a routing tower having a slot, the arcuate members and routing tower being coupled to and extending upwardly from the base. The at least one fiber optic trunk cable is routed into the closure through a respective opening in the gel block, the one or more fiber optic breakout cables are separated from the at least one fiber optic trunk cable within the interior cavity of the closure and routed underneath the plurality of columns and through the slot in the routing tower and connected to respective fiber optic connector adapters, and the plurality of jumper cables are routed into the closure through respective recesses in the gel block and connected to respective fiber optic connectors.

Another aspect of the present invention is directed to a fiber management system assembly. The assembly includes a closure including a base member and a cover which together define an interior cavity, wherein the base member and cover are configured to be secured together in a closed and locked position via one or more locking features, and an adapter panel. The adapter panel includes a base member configured to be secured to the base member of the closure, a trunk cable retention member configured to engage a gel block within the interior cavity of the closure, and one or more fiber connector adapter members configured to secure a plurality of fiber optic connector adapters within interior cavity of the closure.

Another aspect of the present invention is directed to an adapter panel for a fiber management system. The adapter panel includes a base member, a trunk cable retention section, and one or more fiber connector adapter members. The base member is configured to be secured to a base member of an outdoor fiber distribution closure, wherein the base member includes a generally planar main body, a pair of arcuate members coupled to and extending upwardly from the main body, and a mounting section coupled to the main body. The trunk cable retention member has a main body configured to engage with a gel block within an interior cavity of the outdoor fiber distribution closure. The one or more fiber connector adapter members are secured to the mounting section of the base member, wherein each of the one or more fiber connector adapter have a main body and a connector section extending upwardly from the main body, the connector section has a plurality of interior walls that divide the connector section into a plurality of channels, and each of the channels is configured to receive and secure a respective fiber optic connector adapter therein.

It is noted that aspects of the invention described with respect to one embodiment, may be incorporated in a different embodiment although not specifically described relative thereto. That is, all embodiments and/or features of any embodiment can be combined in any way and/or combination. Applicant reserves the right to change any originally filed claim and/or file any new claim, accordingly, including the right to be able to amend any originally filed claim to depend from and/or incorporate any feature of any other claim or claims although not originally claimed in that manner. These and other objects and/or aspects of the present invention are explained in detail in the specification set forth below. Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE FIGURES

FIG. 1A is a perspective view of an outdoor fiber distribution closure (OFDC) for a fiber management system according to embodiments of the present invention.

FIG. 1B is a perspective view of the OFDC of FIG. 1A with the cover removed.

FIG. 2 is a perspective view of an exemplary gel block that may be used in the OFDC of FIG. 1A.

FIG. 3 is a perspective view of an exemplary fiber optic connector adapter that may be used in the OFDC of FIG. 1A.

FIG. 4A is a top front perspective view of an adapter panel for the OFDC of FIG. 1A according to embodiments of the present invention.

FIG. 4B is a top rear perspective view of the adapter panel of FIG. 4A.

FIG. 4C is a top view of the adapter panel of FIG. 4A.

FIG. 4D is a front view of the adapter panel of FIG. 4A.

FIG. 4E is a rear view of the adapter panel of FIG. 4A.

FIG. 5 is a top perspective view of the adapter panel of FIG. 4A with lock pins.

FIG. 6 is a top perspective view of the OFDC of FIG. 1B with the gel block and fiber optic connector adapters removed.

FIG. 7A is a side view of a lock pin according to embodiments of the present invention.

FIG. 7B is an enlarged top perspective view of the base of the gel block secured to one of the lock pins.

FIG. 8 is an exploded perspective view of the adapter panel of FIG. 4A illustrating the ability to stack fiber optic connector adapters within the OFDC according to embodiments of the present invention.

FIG. 9 is a perspective view of a stacking adapter according to embodiments of the present invention.

FIG. 10 is a side view of the adapter panel of FIG. 5 with the gel block and stacked fiber optic connector adapters according to embodiments of the present invention.

FIG. 11 is a top view of the OFDC of FIGS. 1A-1B illustrating exemplary cable routing within the OFDC according to embodiments of the present invention.

FIG. 12 is a top perspective view of an alternative adapter panel having different lock pins according to embodiments of the present invention.

FIG. 13A is a perspective view of an alternative OFDC for a fiber management system according to embodiments of the present invention.

FIG. 13B is a perspective view of the OFDC of FIG. 13A with the cover removed.

FIG. 14A is a perspective view of an alternative OFDC for a fiber management system according to embodiments of the present invention.

FIG. 14B is an exploded perspective view of the OFDC of FIG. 14A.

FIG. 14C is a side section view of the OFDC of FIG. 14A.

FIG. 15 is a perspective view of an alternative adapter panel assembly according to embodiments of the present invention installed within the base member of the OFDC of FIG. 14A.

FIG. 16A is a perspective view of a base tray of the adapter panel assembly of FIG. 15.

FIG. 16B is a side view of the base tray of FIG. 16A.

FIG. 17A is a perspective view of a DLC adapter of the adapter panel assembly of FIG. 15.

FIG. 17B is a side view of the DLC adapter of FIG. 17A.

FIG. 18 is a perspective view of a stacking adapter for the adapter panel assembly of FIG. 15.

FIG. 19 is a front view showing the stacking adapter of FIG. 18 engaged with the DLC adapter of FIGS. 17A-17B according to embodiments of the present invention.

FIG. 20 is a perspective view of a trunk cable retention member for the adapter panel assembly of FIG. 15.

FIG. 21 is a perspective view showing the trunk cable retention member of FIG. 20 engaged with the gel block according to embodiments of the present invention.

FIG. 22A is a perspective view illustrating retention of two fiber trunk cables within the gel block and trunk cable retention member of FIG. 21.

FIG. 22B is an exploded perspective view of the gel block and the trunk cables retention member of FIG. 22A.

FIG. 23 is a top view of the OFDC of FIGS. 14A-14C illustrating exemplary cable routing within the OFDC according to embodiments of the present invention.

### DETAILED DESCRIPTION

The present invention is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

In the figures, certain layers, components, or features may be exaggerated for clarity, and broken lines illustrate optional features or operations unless specified otherwise. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer, or section. Thus, a first element, component, region, layer, or section discussed below could be termed a second element, component, region, layer or section without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

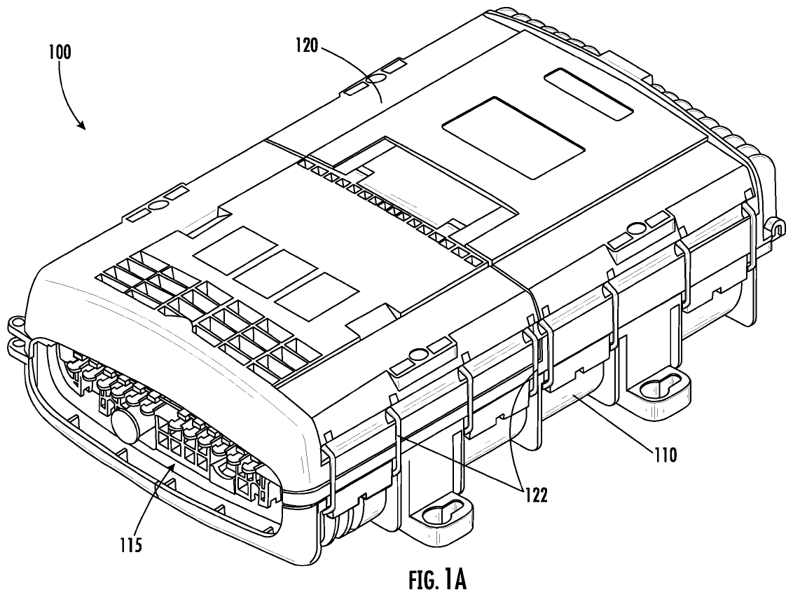

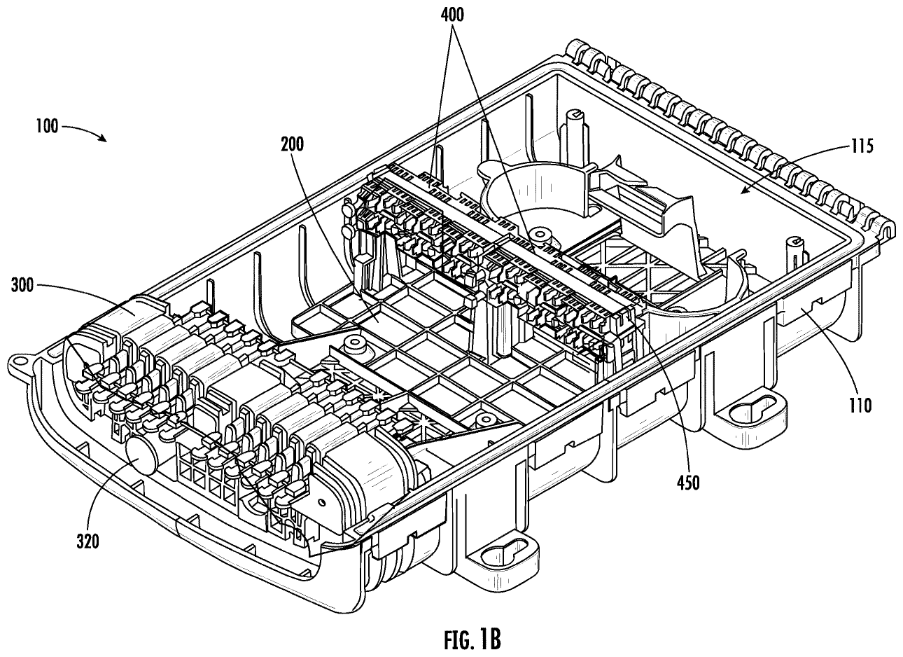

Embodiments of the present invention are directed an adapter panel for an outdoor fiber distribution closure (OFDC) for a fiber management system and related assemblies. The adapter panel may be mounted in an existing OFDC box such that the existing OFDC box which are typically configured for fiber splicing may be repurposed for Fiber to the Antenna (FTTA) applications. Exemplary existing OFDC boxes may include CommScope Products OFDC-A4, OFDC-B8G and OFDC-C12 (CommScope, Inc.). For example, in some embodiments, the adapter panel of the present invention may convert the existing OFDC box to allow for dual LC (DLC) fiber optic connectors at one end of a fiber optic trunk cable to be connected with DLC connectors at the end of remote radio unit (RRU) jumper cables. The present invention provides the advantage of allowing for an environmentally sealed polymeric enclosure instead of a larger metallic (e.g., aluminum) enclosure, which is typically used for these types of FTTA applications. Embodiments of the present invention will now be described in further detail below with reference to FIGS. 1A-23.

Referring to FIGS. 1A-1B, an outdoor fiber distribution closure (OFDC) 100 for a fiber management system according to embodiments of the present invention is illustrated. As shown in FIG. 1A, the OFDC 100 includes a base member 110 and a cover 120 which together define an interior cavity 115. The cover 120 may be pivotably mounted to the base member 110 to allow easy access to the interior cavity 115 by a technician. In some embodiments, the OFDC 100 may further include one or more locking features 122 (e.g., latches) that are configured to secure the cover 120 to the base member 110 in a closed and locked position (e.g., as illustrated in FIG. 1A).

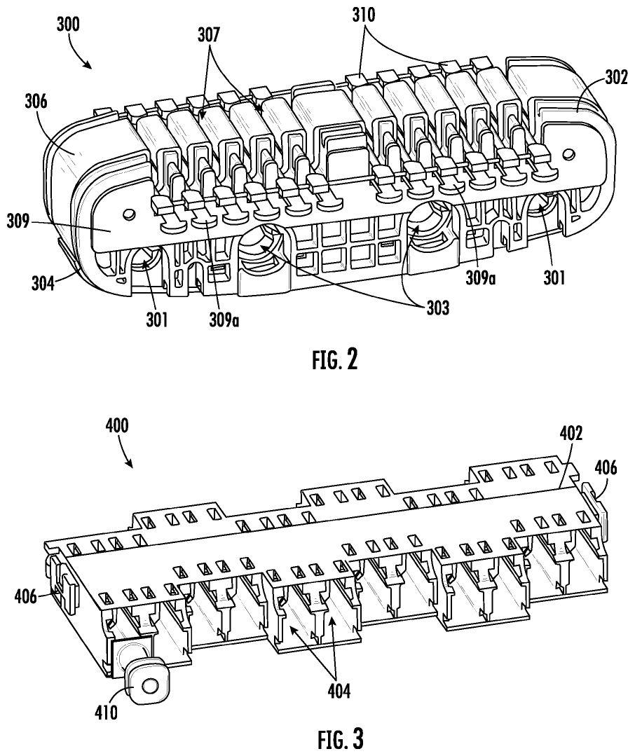

As shown in FIG. 1B, the interior cavity 115 of the OFDC 100 is sized and configured to receive and hold an adapter panel 200 according to embodiments of the present invention. As discussed in further detail below, in some embodiments, the adapter panel 200 of the present invention is configured to secure a gel block 300 and a plurality of fiber optic connector adapters 400 within the interior cavity 115 of the OFDC 100. In some embodiments, as shown in FIGS. 1A-1B, one or more grommet plugs 320 may be used to seal openings within the gel block 300 to help maintain an environmental seal for the OFDC 100 (see also, e.g., FIG. 2).

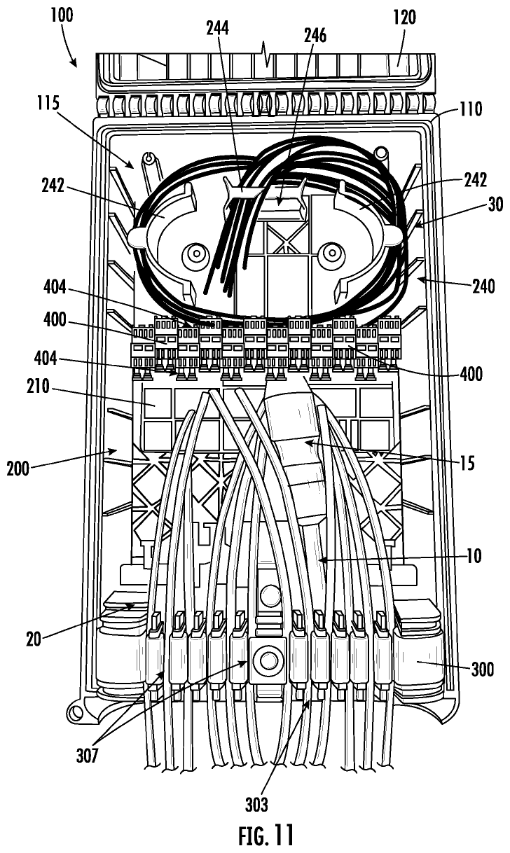

An exemplary gel block 300 that may be used in the OFDC 100 is illustrated in FIG. 2. The gel block 300 is configured to environmentally seal an end of the OFDC 100 when the cover 120 is closed and locked to the base member 110 (see, e.g., FIG. 1A). In some embodiments, the gel block 300 is formed of a thermoplastic material. For example, in some embodiments, the gel block 300 may be formed of an ultra-soft thermoplastic elastomer (TPE) gel. In some embodiments, the material that forms the gel block 300 allows the gel block 300 to be compressed between the cover 120 and the base member 110 to create a seal therebetween. As shown in FIG. 2, in some embodiments, the gel block 300 includes a main body 302, a base 304, and a gel member 306. The gel block 300 has a plurality of openings 301, 303 that are each sized and configured to receive a respective fiber optic trunk cable 10 therethrough (see, e.g., FIG. 11). The gel block 300 further has a plurality of recesses or slots 307. Each of the recesses 307 are sized and configured to receive respective fiber optic jumper cables 20 therethrough (see, e.g., FIG. 11). In addition, in some embodiments, the gel block 300 may have one or more recess plugs 310 that are configured to be inserted into the recesses 307, for example, when the recesses 307 are not being used, thereby allowing the OFDC 100 to remain environmentally sealed.

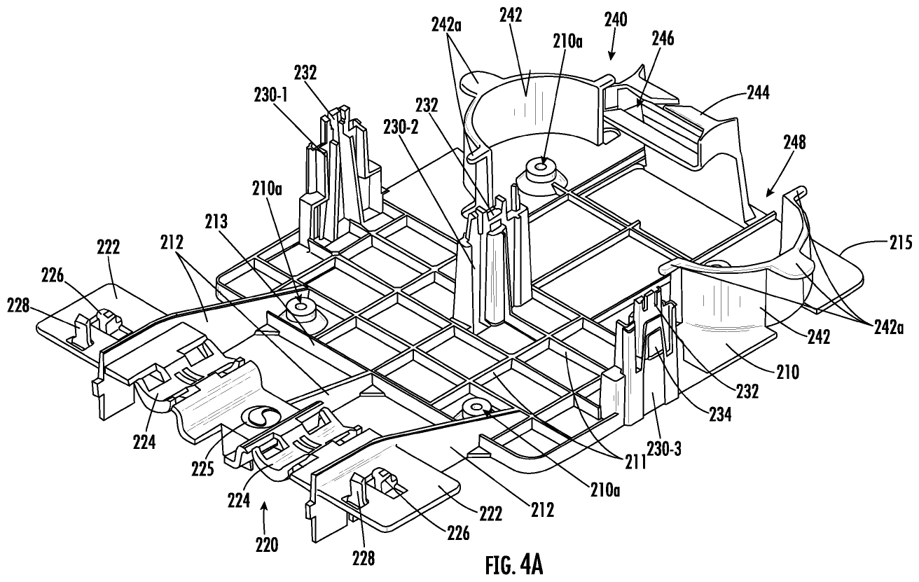

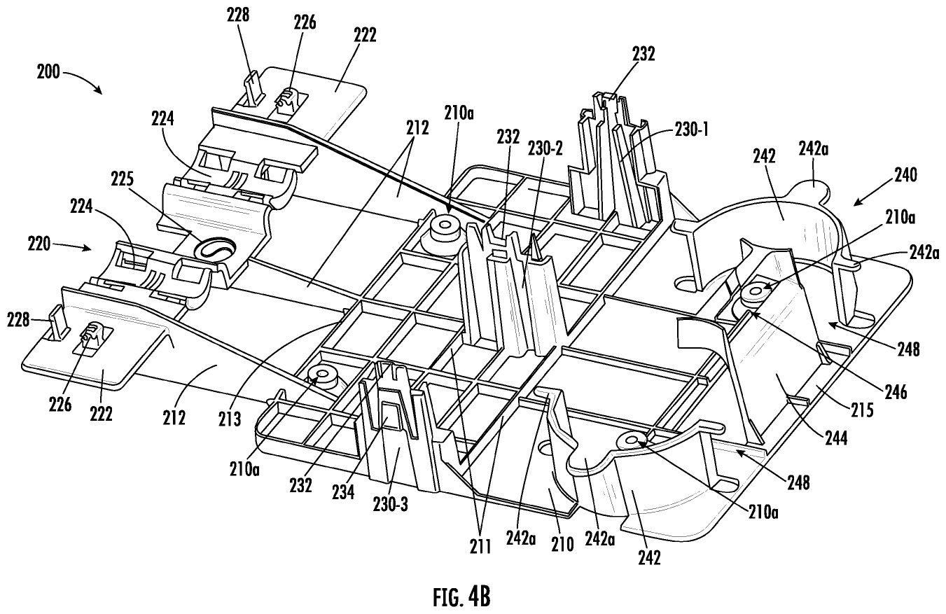

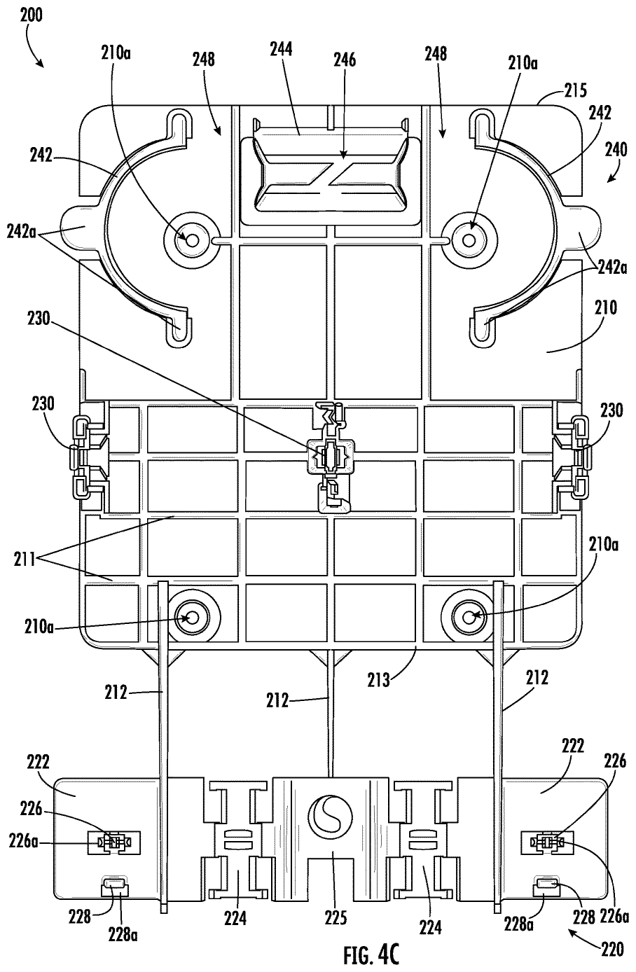

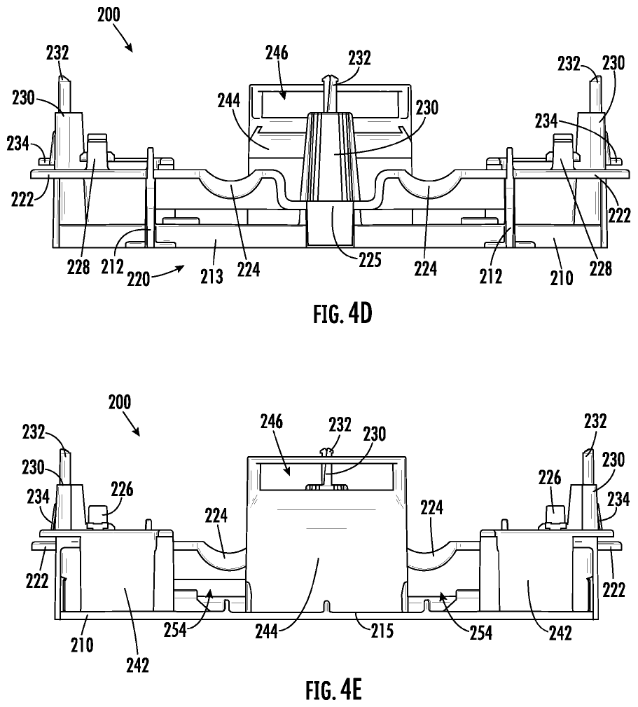

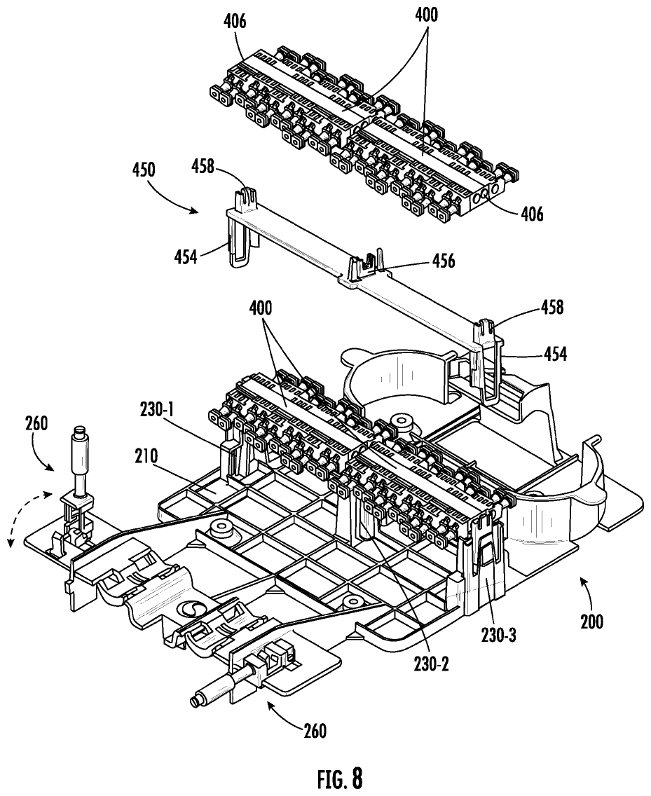

An exemplary fiber optic connector adapter 400 that may be used in the OFDC 100 is illustrated in FIG. 3. In some embodiments, the fiber optic connector adapter 400 is a DLC connector adapter. As shown in FIG. 3, the fiber optic connector adapter 400 has a plurality of ports 404. Each port 404 is configured to receive a fiber optic connector (not shown). For example, as shown in FIG. 3, in some embodiments, the fiber optic connector adapter 400 may comprise twelve (12) ports 404. At opposing ends of the fiber optic connector adapter 400 are securing features 406 which are configured to engage with corresponding securing features 232 of the adapter panel 200 (see, e.g., FIGS. 4A-4E and FIG. 8). In addition, in some embodiments, the fiber optic connector adapter 400 may include one or more plugs 410 that are configured to be inserted into respective ports 404, for example, when the port(s) 404 are not being used. As described in further detail below, in some embodiments, the OFDC 100 of the present invention may accommodate more than one fiber optic connector adapter 400 (see, e.g., FIG. 1B and FIG. 8).

Referring now to FIGS. 4A-4E, the adapter panel 200 according to embodiments of the present invention is illustrated. As noted above, in some embodiments, the adapter panel 200 of the present invention may be configured to be mounted in an existing OFDC box (e.g., within interior cavity 115 of OFDC 100) such that the existing OFDC box configured for fiber splicing may be repurposed for FTTA applications. In some embodiments, the adapter panel 200 may be formed of a polymeric material, for example, polycarbonate.

As shown in FIGS. 4A-4E, the adapter panel 200 has a base 210. The base 210 is configured to be secured the base member 110 of the OFDC 100. For example, in some embodiments, the base 210 of the adapter panel 200 comprises one or more apertures 210a that are configured to receive a fastener (not shown) to secure the base 210 to the base member 110 of the OFDC 100. In some embodiments, the base 210 of the adapter panel 200 may further comprise a plurality of ridges or ribs 211 which may help to provide structural support to the adapter panel 200.

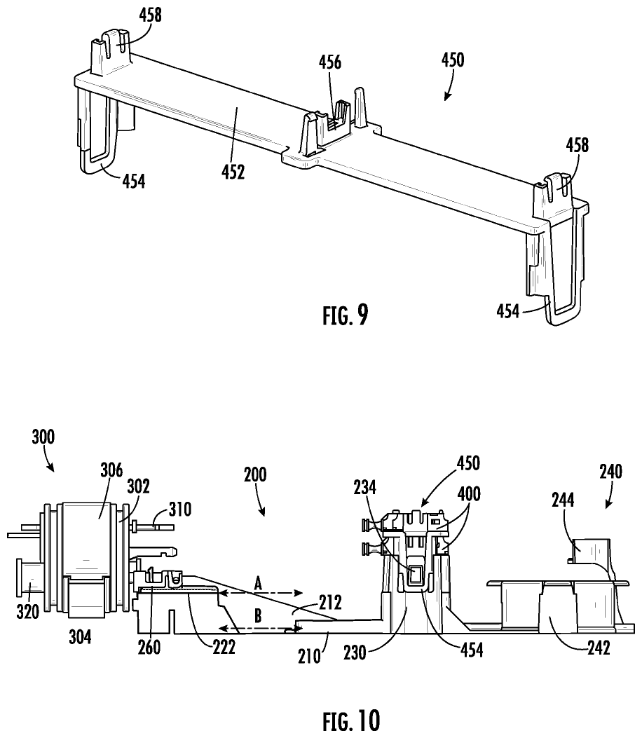

The adapter panel 200 further includes a cable retention section 220 having a main body 225. The cable retention section 220 may be coupled to an end 213 of the base 210 via a plurality of extension members 212. As shown in FIGS. 4A-4B, in some embodiments, the adapter panel 200 may comprise three extension members 212. In some embodiments, the extension members 212 may be tapered such that the cable retention section 220 may be positioned on a plane (A) that extends above and parallel relative to a plane (B) of the base 210 (see, e.g., FIG. 10).

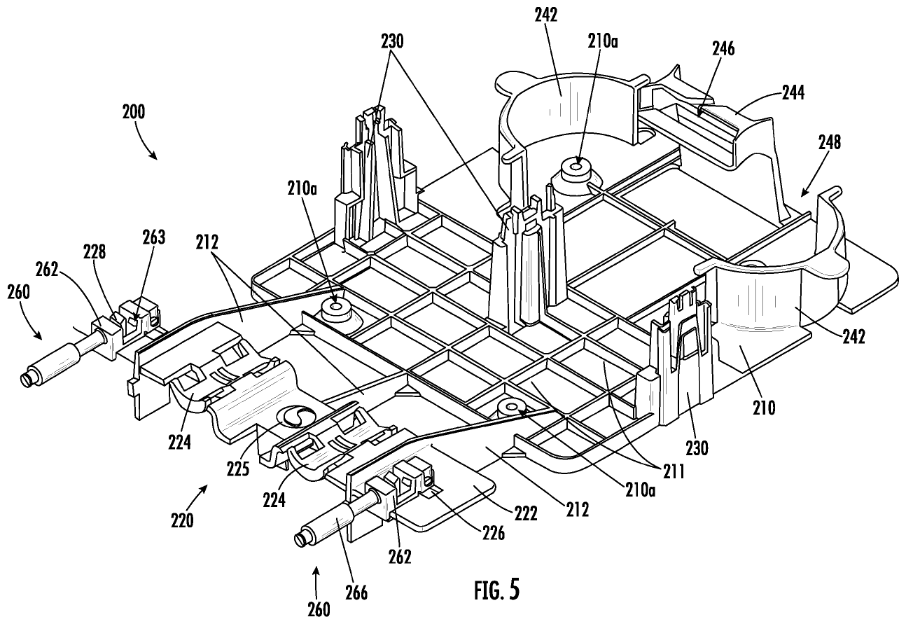

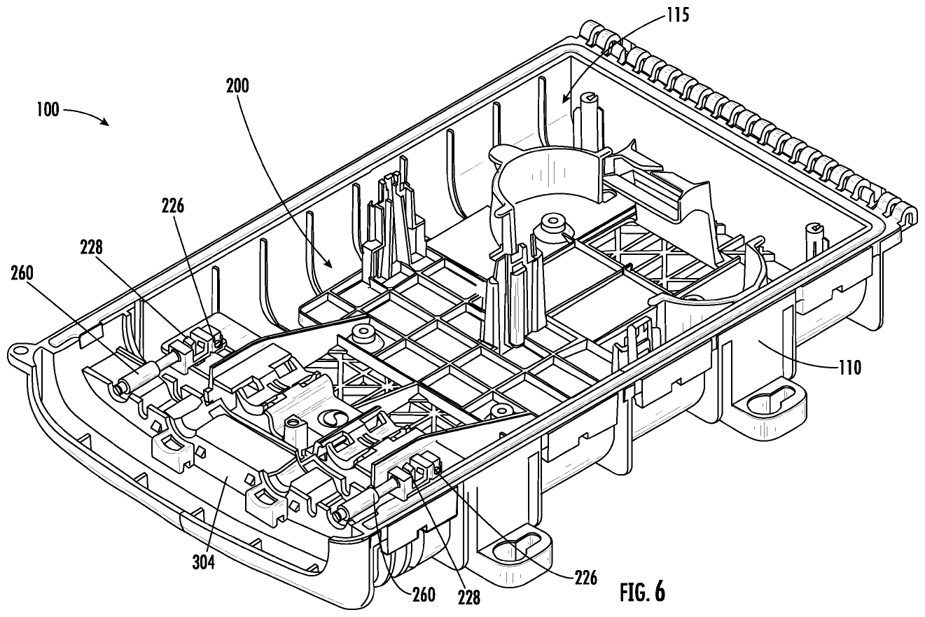

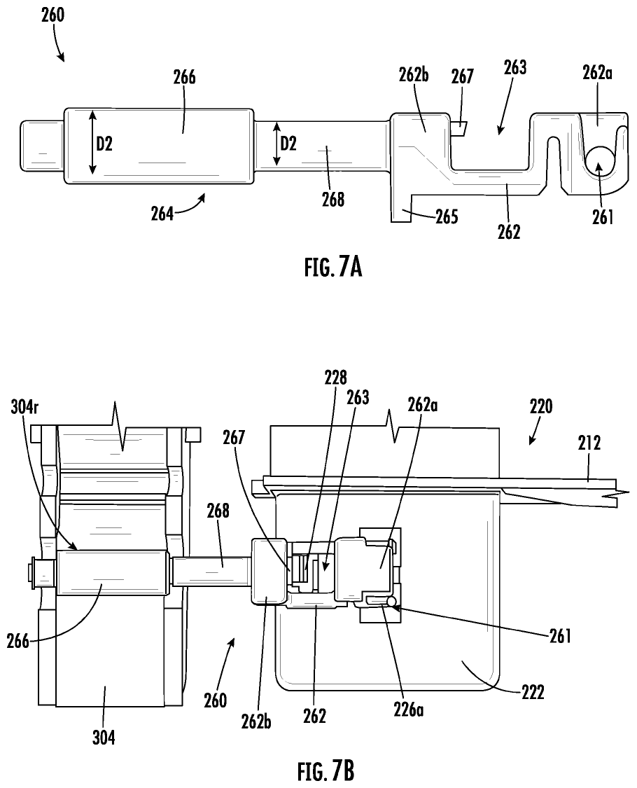

As shown in FIGS. 4A-4E, in some embodiments, the main body 225 of the cable retention section 220 comprises a pair of recesses or channels 224. The recesses 224 are configured to help guide a respective trunk cable 10 being routed into the interior cavity 115 of the OFDC 100 while also providing support to the trunk cable 10 (see, e.g., FIG. 11). In some embodiments, the trunk cable 10 may be further secured to the cable retention section 220 via zip-ties or similar securing mechanism. In some embodiments, the cable retention section 220 further comprises a pair of wing or flange members 222, each flange member 222 extending outwardly from opposing ends of the main body 225. In some embodiments, the flange members 222 may help to position and/or fit the adapter panel 200 within the interior cavity 115 of the OFDC 100. For example, the flange members 222 may extend outwardly such that an outer edge of the flange members 222 contact an inner surface of the base member 110 of the OFDC 100 (see, e.g., FIG. 6). As shown in FIGS. 4A-4E, in some embodiments, each flange member 222 comprises securing features (e.g., a hinge member 226 and a locking member 228) that are configured to engage with a respective snap or lock pin 260 (see also, e.g., FIG. 5, FIG. 6, FIGS. 7A-7B and FIG. 8). As discussed in further detail below, the snap or lock pins 260 are configured to engage and secure the base 304 of the gel block 300 to the adapter panel 200 (see, e.g., FIG. 6, FIG. 7B, and FIG. 10).

Still referring to FIGS. 4A-4E, the adapter panel 200 further includes a plurality of columns or support members 230 that are coupled to or integral with the base 210 and extend upwardly therefrom. As shown in FIGS. 4A-4B, in some embodiments, the adapter panel 200 comprises three columns 230, i.e., two outer columns 230-1, 230-3 and one inner column 230-2 (see also, e.g., FIG. 8 and FIG. 11). The columns 230 are configured to engage with the fiber optic connector adapter(s) 400 and secure the fiber optic connector adapters 400 to the adapter panel 200. For example, in some embodiments, a top portion of each column 230 comprises a securing feature 232 that is configured to engage with the corresponding securing features 406 on the ends of the fiber optic connector adapter(s) 400. In some embodiments, the corresponding securing features 406, 232 of the adapters 400 and columns 230 may comprise corresponding snap-fit type securing mechanisms, such as cantilevered latches. In some embodiments, the securing feature 232 of inner column 230-2 is configured to engage the securing features 406 at respective ends of two different fiber optic connector adapters 400 and the securing features 232 of the outer columns 230-1, 230-3 are configured to engage the securing features 406 residing at the opposing ends of the respective fiber optic connector adapters 400 (see, e.g., FIG. 8 and FIG. 11).

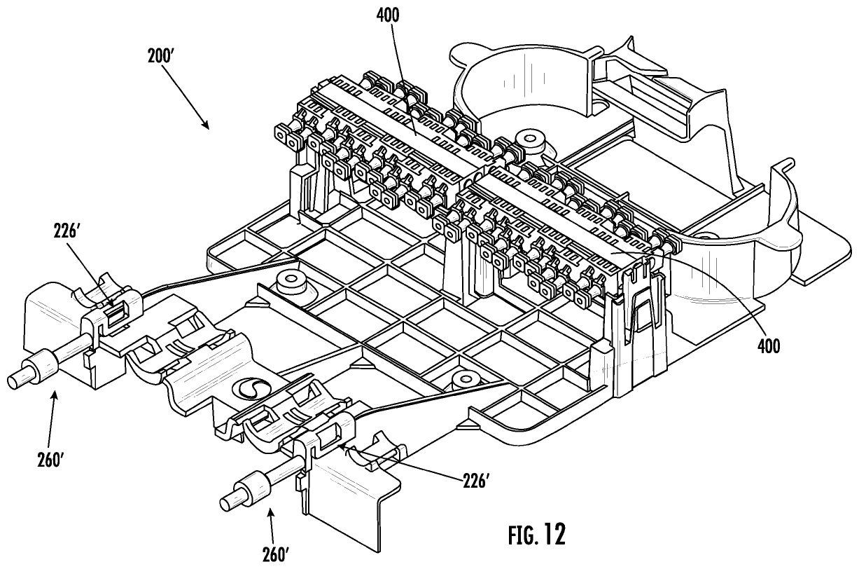

The columns 230 are also configured to support and hold the fiber optic connector adapter(s) 400 a distance (D) above the base 210, thereby providing sufficient space below the adapter(s) 400 for a trunk cable transition enclosure 15 and routing of fiber optic breakout cables 30 (i.e., fiber optic cable(s) 30 that have been separated from the trunk cable 10 and routed from the trunk cable transition 15) within the interior cavity 115 of the OFDC 100 (see, e.g., FIG. 1B, FIG. 11, and FIG. 12). For example, in some embodiments, the columns 230 are configured to position the fiber optic connector adapters 400 a distance (D) above the base 210 of the adapter panel 200 in the range of about 60 mm to about 62 mm.

In addition, in some embodiments, the outer columns 230-1, 230-3 may each further comprise a second securing feature 234. As discussed in further detail below, in some embodiments, the second securing features 234 on the outer columns 230-1, 230-3 may be configured to engage with corresponding securing features 454 of a stacking adapter 450 which may allow for at least two additional fiber optic connector adapters 400 to be stacked above the fiber optic connectors 400 secured to the columns 230-1, 230-2, 230-3, thereby providing the ability to increase the number of fiber optic connections that can be made within the OFDC 100 (see, e.g., FIG. 8, FIG. 9, and FIG. 10).

Still referring to FIGS. 4A-4E, the adapter panel 200 of the present invention further includes a cable routing section 240 located proximate to an opposing end 215 of the base 210 (i.e., opposite the end 213 of the cable retention section 220). The cable routing section 240 may comprise a pair of arcuate members 242 coupled to and extending upwardly from the base 210. The arcuate members 242 are configured such that redundant or excess fiber optic breakout cables 30 may be wound around the arcuate members 242 without exceeding a minimum bend radius of the fiber optic breakout cables 30 (see, e.g., FIG. 11). In some embodiments, each arcuate member 242 may have one or more tabs 242a extending radially outwardly from a top edge of the respective member 242. The tabs 242a may be configured to help prevent the excess fiber optic breakout cables 30 wound on the arcuate members 242 from slipping off the respective members 242. In some embodiments, the cable routing section 240 also includes a routing tower 244. The routing tower 244 is configured to guide the fiber optic breakout cables 30 toward the fiber optic connector adapters 400 for connection (see also, e.g., FIG. 11). In some embodiments, the routing tower 244 may comprise a slot 246 to help further guide the fiber optic breakout cables 30 toward the fiber optic connector adapters 400 within the OFDC 100.

Referring to FIG. 5 and FIG. 6, the adapter panel 200 is shown with a pair of lock pins 260 secured to the cable retention section 220. As discussed above, and shown in FIG. 5, the lock pins 260 are configured to engage with the hinge member 226 and lock member 228 on the flange members 222 of the cable retention section 220 (see also, e.g., FIG. 7B). As shown in FIG. 6, the lock pins 260 are also configured to engage the base member 304 of the gel block 300 which holds the base member 304 within the OFDC 100 (see also, e.g., FIG. 7B). The lock pins 260 are configured to pivot about the hinge member 226 (see, e.g., FIG. 8) which allows positioning of the base member 304 within the OFDC 100. After the base member 304 has been positioned in the OFDC 100, the lock pins 260 are pivoted about the respective hinges 226 until the lock pins 260 engage the respective lock members 228 of the flange members 222 and recess 304r of the base member 304, thereby securing the base member 304 of the gel block 300 in position within the OFDC 100 (see also, e.g., FIG. 7B).

FIG. 7A is a side view of one of the lock pins 260 according to embodiments of the present invention. FIG. 7B is an enlarged top perspective view illustrating one of the lock pins 260 engaged with the base member 304 of the gel block 300 according to embodiments of the present invention.

As shown in FIG. 7A, in some embodiments, each lock pin 260 has a main body 262 having a hinge section 262a and a locking section 262b. The main body 262 comprises an aperture 263 configured to receive the lock member 228 residing on the flange member 222 of the cable retention section 220 (i.e., when the lock pin 260 is pivoted to a locked position). The hinge section 262a comprises opposing apertures 261 configured to receive corresponding protrusions 226a on the hinge member 226 of the cable retention section 220 which allows the lock pin 260 to pivotably move about the hinge member 226. In some embodiments, the locking section 262b may comprise a protrusion 267 configured to engage the lock member 228 of the cable retention section 220. For example, in some embodiments, the lock member 228 and protrusion 267 may function together as a snap-fit type securing mechanism when the lock pin 260 is pivoted to secure and hold the base member 304 of the gel block 300 in position within the OFDC 100.

In some embodiments, the locking section 262b of the lock pin 260 may further comprise a flange 265 extending downwardly therefrom. The flange 265 may create a stop or shoulder adjacent to or in contact with the flange member 222 of the cable retention section 220. In some embodiments, the flange 265 may help to mitigate side-to-side movement by the lock pin 260 relative to the respective flange member 222.

As shown in FIG. 7A, each lock pin 260 further comprises an arm member 264 coupled to the locking section 262b of the main body 262 and extending outwardly therefrom. In some embodiments, the arm member 264 has a cylindrical shape with a first segment 266 having a first diameter (D1) and a second segment 268 having a second smaller diameter (D2). As shown in FIG. 7B, the arm member 264 of the lock pins 260 is configured to be received within a respective recess 304r of the base member 304 (i.e., which forms part of opening 301 of the gel block 300, see, e.g., FIG. 2). In some embodiments, the arm member 264 of the lock pins 260 helps to hold the base member 304 of the gel block 300 in place within the OFDC 100 while cables (e.g., trunk cables 10 and/or jumper cables 20) are being installed in the OFDC 100.

Referring now to FIGS. 8-10, as discussed above, in some embodiments, the adapter panel 200 of the present invention may further include a stacking adapter 450. The stacking adapter 450 may allow for at least two additional fiber optic connector adapters 400 to be stacked above of the fiber optic connector adapters 400 that are secured to the plurality of columns 230-1, 230-2, 230-3 of the adapter panel 200 (see, e.g., FIGS. 8 and 10). Thus, in some embodiments, the stacking adapter 450 can allow the number of fiber optic connections with the OFDC 100 to be increased from 24 connections up to 48 fiber connections (i.e., with each fiber optic connector adapter 400 providing up to 12 connections). FIG. 8 also illustrates the pivotability of the lock pins 260 which allows the lock pins 260 to engage with or disengage from the base member 304 of the gel block 300 as described herein.

The stacking adapter 450 according to embodiments of the present invention is illustrated in FIG. 9. As shown in FIG. 9, the stacking adapter 450 comprises a main body 452 and a pair of securing features 454 extending downwardly from opposing ends of the main body 452. As discussed above, and shown in FIG. 10, the pair of securing features 454 of the stacking adapter 450 are configured to engage with respective second securing features 234 on the outer columns 230-1, 230-3 as described herein. In some embodiments, the corresponding securing features 234, 454 of the columns 230-1, 230-3 and stacking adapter 450 may comprise snap-fit type securing mechanisms.

As shown in FIG. 9 and FIG. 10, the stacking adapter 450 further comprises additional securing features 456, 458 extending upwardly from the main body 452. Similar to the securing features 232 on the top of each of the columns 230-1, 230-2, 230-3, the additional securing features 456, 458 of the stacking adapter 450 are configured to engage with the securing features 406 located at opposing ends of the additional fiber optic connector adapters 400. In some embodiments, the additional securing feature 456 located proximate to a center of the main body 452 of the stacking adapter 450 is configured to engage the securing features 406 at respective ends of two different fiber optic connector adapters 400 and the additional securing features 458 located proximate to opposing ends of the main body 452 of the stacking adapter 450 are configured to engage the securing features 406 residing at the opposing ends of the respective fiber optic connector adapters 400.

FIG. 11 illustrates an exemplary configuration for the routing of cables 10, 20, 30 within the OFDC 100 using the adapter panel 200 according to embodiments of the present invention. As shown in FIG. 11, a fiber optic trunk cable 10 is routed through one of the openings 301, 303 of the gel block 300 and into the interior cavity 115 of the OFDC 100. Within the interior cavity 115 of the OFDC 100, fiber optic cables 30 are separated from the trunk cable 10 at transition 15 (i.e., “break out”). The fiber optic breakout cables 30 are routed underneath the fiber optic connector adapters 400 which are positioned a distance (D) above the base 210 of the adapter panel 200 by the plurality of columns 230-1, 230-2, 230-3. The excess or redundant length of the fiber optic breakout cables 30 may be wound around the arcuate members 242 of the cable routing section 240. The ends of the fiber optic breakout cables 30 are feed through the slot 246 of the routing tower 244 and routed toward the fiber optic connector adapters 400. The fiber optic breakout cables 30 may then be connected to respective ports 404 of the fiber optic connector adapters 400. Fiber optic jumper cables 20 are routed through respective slots 307 in the gel block 300 and into the interior cavity 115 of the OFDC 100. The fiber optic jumper cables 20 may then be connected to corresponding ports 404 of the fiber optic connector adapters 400 to complete the connections within the OFDC 100.

Referring now to FIG. 12, an alternative adapter panel 200′ according to embodiments of the present invention is illustrated. Properties and/or features of the adapter panel 200′ may be as described above in reference to the adapter panel 200 shown in FIG. 1B, FIGS. 4A-6, FIG. 8, FIG. 10 and FIG. 11 and duplicate discussion thereof may be omitted herein for the purposes of discussing FIG. 12. The adapter panel 200′ differs from the adapter panel 200 described herein in that the lock pins 260′ are removably attached to the adapter panel 200′ via respective snap-fit type securing mechanisms 226′ instead of a hinge member 226 and locking member 228 as described herein. To secure the base member 304 of the gel block 300 in the OFDC 100, the lock pins 260′ are removed from the adapter panel 200′. After the base member 304 has been positioned in the OFDC 100, the lock pins 260′ are snapped/secured back onto place on the adapter panel 200′ via the snap-fit type securing mechanisms 226′, thereby securing the base member 304 of the gel block 300 in position within the OFDC 100.

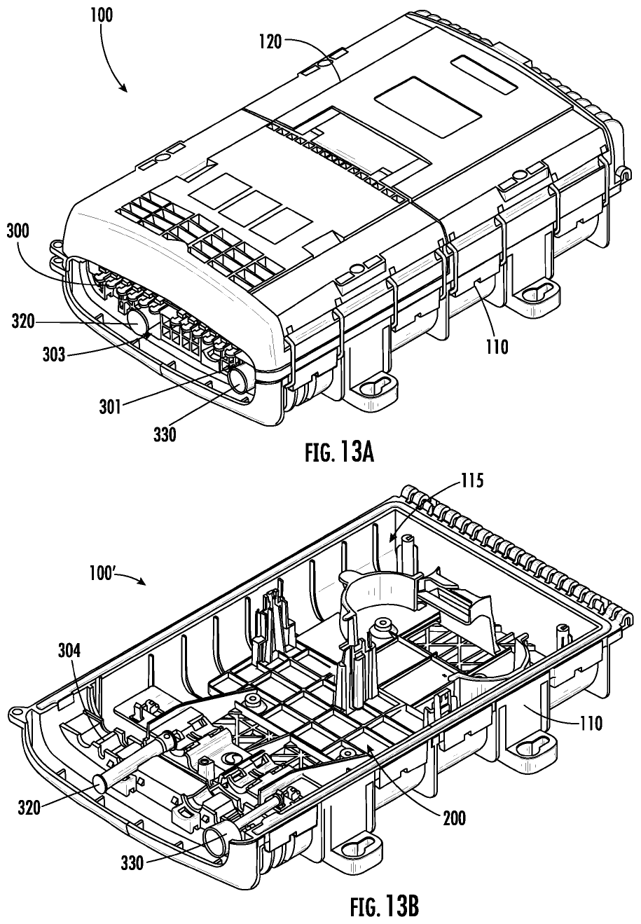

Referring to FIGS. 13A-13B, an alternative outdoor fiber distribution closure (OFDC) 100′ for a fiber management system according to embodiments of the present invention is illustrated. Properties and/or features of the OFDC 100′ may be as described above in reference to the OFDC 100 shown in FIGS. 1A-1B, FIG. 6, and FIG. 11 and duplicate discussion thereof may be omitted herein for the purposes of discussing FIGS. 13A-13B. The OFDC 100′ differs from the OFDC 100 described herein in that the lock pins 260, 260′ are replaced with grommet plugs 330. Similar to the grommet plugs 320 described herein, in some embodiments, the grommet plugs 330 may be used to seal openings 301 within the gel block 300 that are not being used to help maintain an environmental seal for the OFDC 100′.

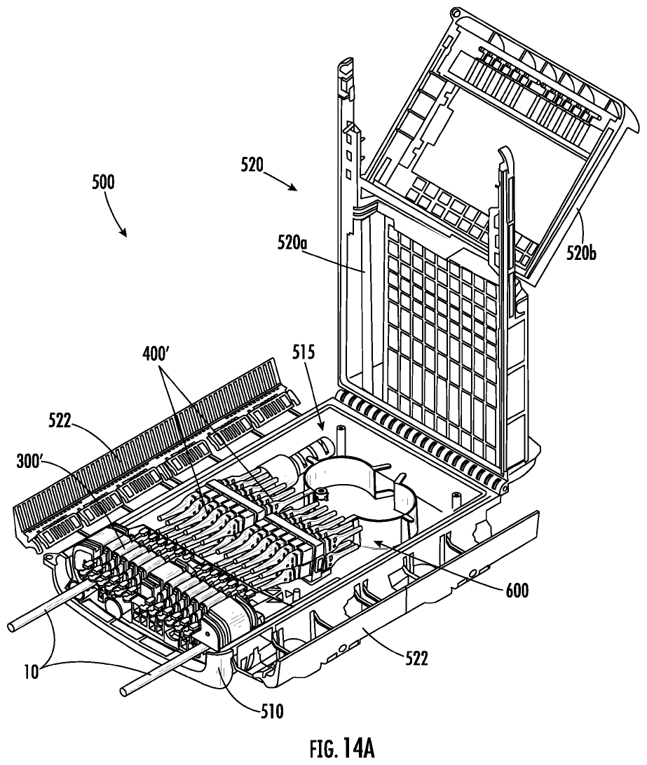

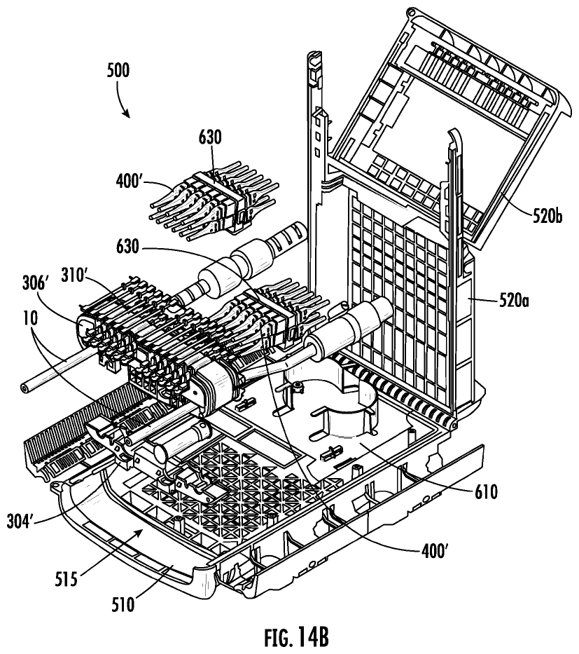

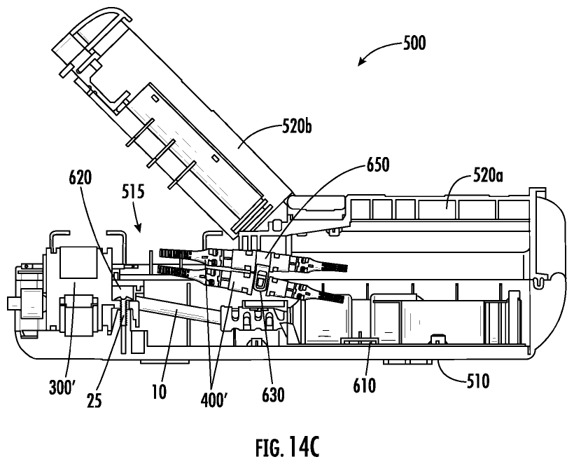

Referring to FIGS. 14A-14C, an alternative outdoor fiber distribution closure (OFDC) 500 for a fiber management system according to embodiments of the present invention is illustrated. Properties and/or features of the OFDC 500 may be as described above in reference to the OFDCs 100, 100′ shown in FIGS. 1A-1B, FIG. 6, FIG. 11, and FIGS. 13A-13B and duplicate discussion thereof may be omitted herein for the purposes of discussing FIGS. 14A-14B. The OFDC 500 differs from the OFDCs 100, 100′ described herein in that a different adapter panel 600 according to embodiments of the present invention is installed within the OFDC 500.

As shown in FIGS. 14A-14C, similar to the other OFDCs 100, 100′ described herein, the OFDC 500 includes a base member 510 and a cover 520 which together define an interior cavity 515. The cover 520 may be pivotably mounted to the base member 510 to allow easy access to the interior cavity 515 by a technician. In some embodiments, the cover 520 may comprise a first section 520a and a second section 520b. The second section 520b may be pivotably coupled to the first section 520a such that only a portion of the cover 520 may be opened (e.g., the second section 520b) to allow access to the interior cavity 515 of the OFDC 500 (see, e.g., FIG. 14C). In some embodiments, the OFDC 500 may further include one or more locking features 522 (e.g., latches) that are configured to secure the cover 520 to the base member 510 in a closed and locked position.

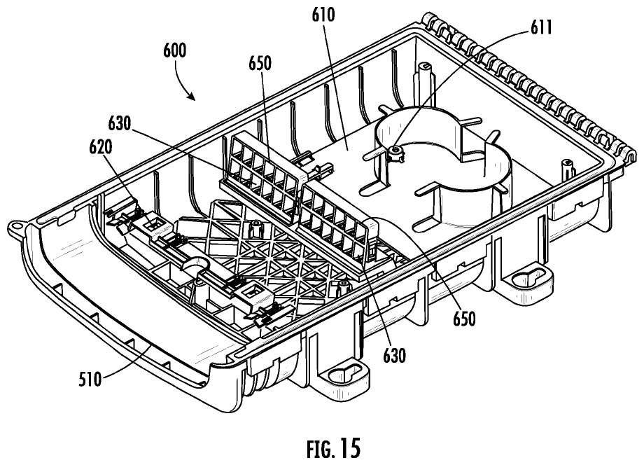

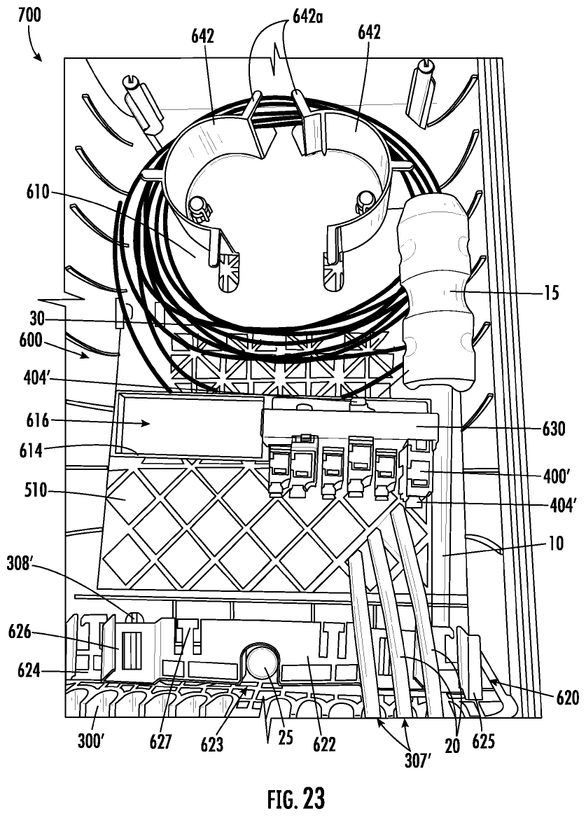

As shown in FIGS. 14A-14C (see also, e.g., FIGS. 15 and 23), the interior cavity 515 of the OFDC 500 is sized and configured to receive and hold the adapter panel 600 according to embodiments of the present invention. As discussed in further detail below, in some embodiments, components of the adapter panel 600 may be configured to secure a gel block 300′ and/or a plurality of fiber optic connector adapters 400′ within the interior cavity 515 of the OFDC 500.

Referring now to FIGS. 15-22B, the adapter panel 600 according to embodiments of the present invention is illustrated. As noted above, in some embodiments, the adapter panel 600 of the present invention may be configured to be mounted in an existing OFDC box (e.g., within interior cavity 515 of OFDC 500) such that the existing OFDC box configured for fiber splicing may be repurposed for FTTA applications. In some embodiments, the adapter panel 600 may be formed of a polymeric material, for example, polycarbonate.

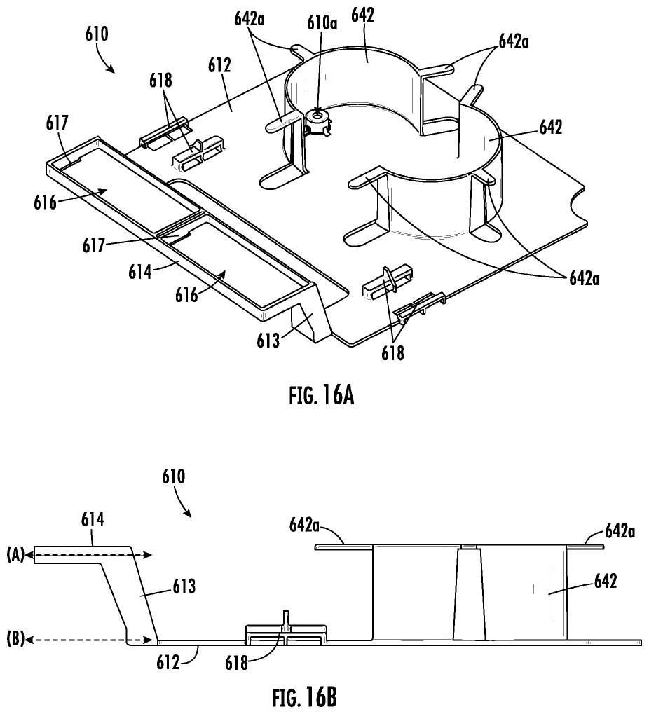

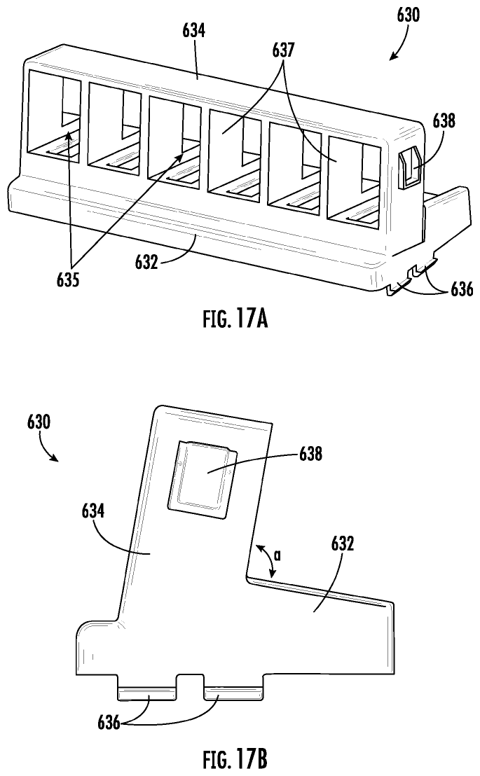

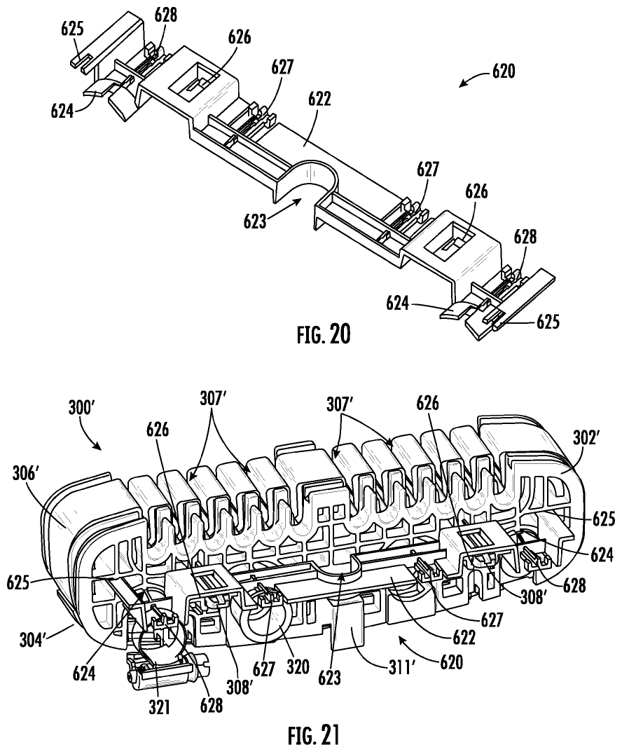

As shown in FIGS. 15-21, the adapter panel 600 comprises a base member 610 (see, e.g., FIGS. 16A-16B), a trunk cable retention member 620 (see, e.g., FIG. 20), and one or more fiber connector adapter members 630 (see. e.g., FIG. 17A-17B). As shown in FIG. 15, the base member 610 is configured to be secured the base member 510 of the OFDC 500. For example, in some embodiments, the base member 610 of the adapter panel 600 comprises one or more apertures 610a that are configured to receive a fastener 611 to secure the base member 610 of the adapter panel 600 to the base member 510 of the OFDC 500. In some embodiments, the base member 610 of the adapter panel 600 may further comprise additional securing features 618 that are configured to secure a trunk cable 10 routed into the interior cavity 515 of the OFDC 500 to the base member 610 of the adapter panel 600. In some embodiments, the additional securing features 618 may comprise a snap-fit mechanism.

Referring to FIGS. 16A-16B, the base member 610 of the adapter panel 600 is illustrated. As shown in FIGS. 16A-16B, the base member 610 includes a generally planar main body 612. Similar to the cable routing section 240 of adapter panel 200 described herein, the adapter panel 600 includes a pair of arcuate members 642 that are coupled to and extend upwardly from the main body 612 of the base member 610. The arcuate members 642 are configured such that redundant or excess fiber optic breakout cables 30 may be wound around the arcuate members 642 without exceeding a minimum bend radius of the fiber optic breakout cables 30 (see, e.g., FIG. 23). In some embodiments, each arcuate member 642 may have one or more tabs 642a extending radially outwardly from a top edge of the respective member 642. The tabs 642a may be configured to help prevent the excess fiber optic breakout cables 30 wound on the arcuate members 642 from slipping off the respective members 642.

In addition, the base member 610 of the adapter panel 600 includes a mounting section 614 coupled to the main body 612. The mounting section 614 is configured to secure the one or more fiber optic connector adapter members 630 within the OFDC 500. In some embodiments, the mounting section 614 has one or more recessed areas 616 that are each configured to receive and hold a respective fiber connector adapter member 630 therein (see, e.g., FIG. 15 and FIG. 23). In some embodiments, the mounting section 614 has one or more apertures 617 that are each configured to receive a respective securing feature 636 (e.g., a snap-fit type securing mechanism) of the fiber connector adapter member 630 to secure the fiber connector adapter member 630 to the mounting section 614.

In some embodiments, the base member 610 of the adapter panel 600 may further comprise one or more extension members 613. In some embodiments, the extension members 613 are configured to position the mounting section 614 on a plane (A) that extends above and is parallel relative to a plane (B) of the main body 612 of the base member 610 (see, e.g., FIG. 16B).

Referring to FIGS. 17A-17B, a fiber connector adapter member 630 of the adapter panel 600 according to embodiments of the present invention is illustrated. As shown in FIGS. 17A-17B, the fiber connector adapter member 630 has a main body 632 and a connector section 634 extending upwardly therefrom. The connector section 634 has a plurality of interior walls 637 that divide the connector section 634 into a plurality of channels 635. Each of the channels 635 is configured to receive and secure a respective fiber optic connector adapter 400′ therein (see, e.g., FIGS. 14A-14C and FIG. 23). As shown in FIG. 17B, in some embodiments, a portion of the main body 632 may be tapered. In some embodiments, the tapered portion of the main body 632 may position the fiber optic connector adapters 400′ at an upward angle, thereby making it easier for a technician to connect the fiber optic jumper cables 20 thereto (see, e.g., FIG. 14C and FIG. 23). As further shown in FIG. 17B, in some embodiments, the connector section 634 may extend upwardly from the main body 632 at an angle (a). In some embodiments, the connector section 634 extends upwardly from the main body 632 at an angle (a) in a range of between about 5 degrees and about 10 degrees.

In some embodiments, the fiber connector adapter member 630 comprises one or more securing features 636 extending from a bottom edge of the main body 632. In some embodiments, the one or more securing features 636 comprise a snap-fit type securing mechanism. As discussed above, in some embodiments, the one or more securing features 636 are configured to engage with a corresponding apertures 617 in the mounting section 614 of the base member 610 to secure the fiber connector adapter member 630 to the mounting section 614.

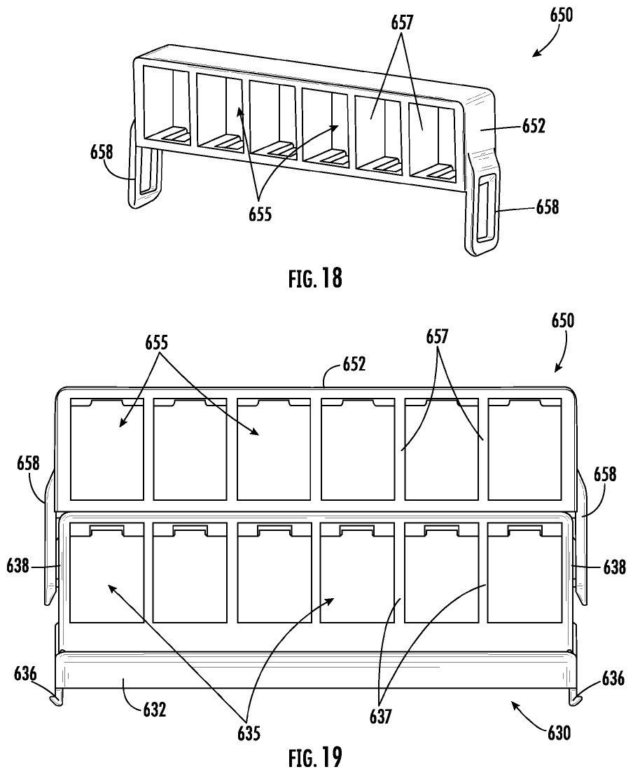

In some embodiments, the connector section 634 of the fiber connector adapter member 630 further comprises one or more additional securing features 638. The additional securing features 638 may reside on an exterior surface of the connector section 634. In some embodiments, the one or more additional securing features 638 comprise a snap-fit type securing mechanism. In some embodiments, the one or more additional securing features 638 are configured to engage with a corresponding securing feature 658 for a stacking adapter 650 (see, e.g., FIG. 19).

In some embodiments, the adapter panel 600 may optionally include one or more stacking adapters 650 that are configured to engage a corresponding fiber connector adapter member 630 within the OFDC 500. A stacking adapter 650 according to embodiments of the present invention is illustrated in FIG. 18. In some embodiments, the stacking adapter(s) 650 may allow for additional fiber optic connector adapters 400′ to be stacked above (on top of) the fiber optic connector adapters 400′ that are secured to the fiber connector adapter member 630 of the adapter panel 600 (see, e.g., FIG. 14C and FIG. 19), thereby increasing the number of fiber optic connections that may be made within the OFDC 500. For example, in some embodiments, the adapter panel 600 may include two stacking adapters 650 (i.e., one for each fiber connector adapter member 630).

As shown in FIG. 18, the stacking adapter 650 has a main body 652 having a plurality of interior walls 657 that divide the main body 652 into a plurality of channels 655. Similar to the channels 635 of the fiber connector adapter member 630 described herein, each channel 655 of the stacking adapter 650 is configured to receive and secure a respective fiber optic connector adapter 400′ therein (see, e.g., FIG. 14C). In some embodiments, the number of channels 655 of the stacking adapter 650 is equal to the number of channels 635 of the fiber connector adapter member 630. As further shown in FIG. 18, the stacking adapter 650 also comprises a pair of securing features 658 extending downwardly from opposing ends of the main body 652. As described herein, the securing features 658 are configured to engage with a corresponding securing feature 638 on an exterior surface of the connector section 634 of the fiber connector adapter member 630. The corresponding securing features 658, 638 secure the stacking adapter 650 to the fiber connector adapter member 630 in a stacked relationship within the interior cavity 515 of the OFDC 500 (see, e.g., FIG. 19).

FIG. 19 illustrates a stacking adapter 650 secured to a fiber connector adapter member 630 in a stacked relationship according to embodiments of the present invention. As shown in FIG. 19, in some embodiments, the channels 655 of the stacking adapter 650 are in alignment with the channels 635 of the fiber connector adapter member 630.

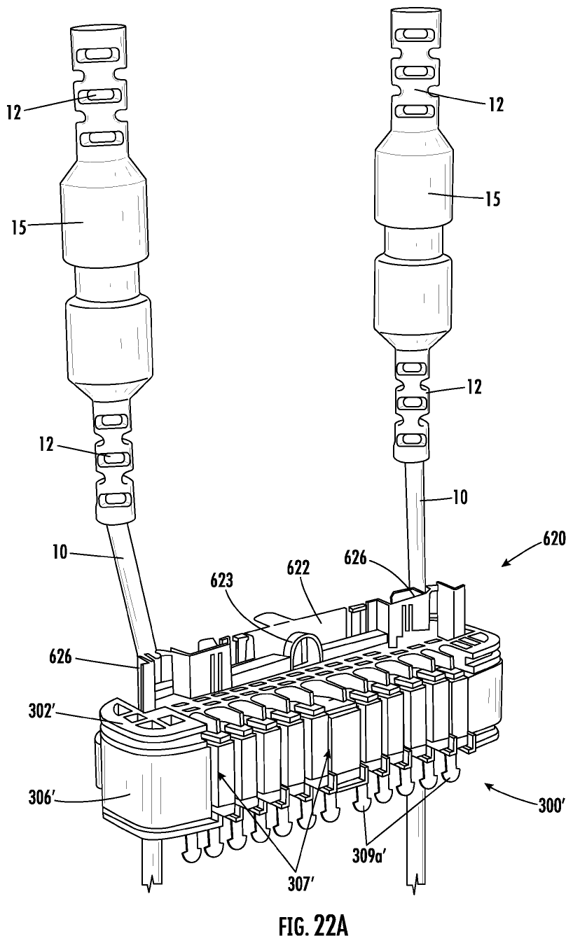

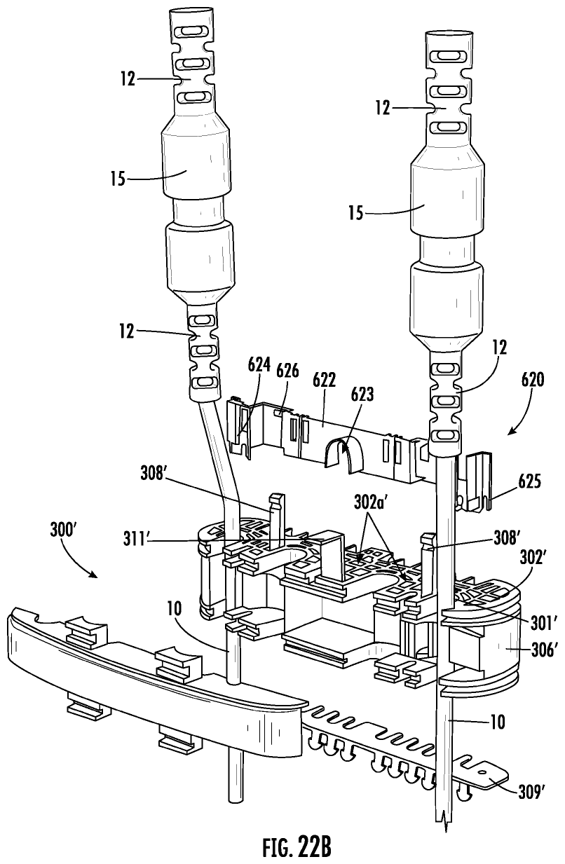

Referring to FIGS. 20 and 21, the trunk cable retention member 620 of the adapter panel 600 according to embodiments of present invention is illustrated. As shown in FIG. 20, the trunk cable retention member 620 has a main body 622 that is configured to engage with the gel block 300′ and provide support to the trunk cables 10 entering the OFDC 500 through the gel block 300′ (see also, e.g., FIGS. 22A-22B). For example, in some embodiments, the main body 622 of the trunk cable retention member 620 comprises one or more different engagement mechanisms 624, 625, 626 that are configured to engage with the gel block 300′ and secure the trunk cable retention member 620 to the gel block 300′ within the OFDC 500. In some embodiments, the one or more engagement mechanisms 624, 625, 626 are snap-fit type securing mechanisms.

In some embodiments, the gel block 300′ may be secured to the base member 510 of the OFDC 500 by a fastener 25 (see, e.g., FIG. 14C and FIG. 23). In some embodiments, the fastener 25 is received through a securing flange 311′ that extends outwardly from the main body 302′ of the gel block 300′ (see, e.g., FIG. 21 and FIG. 22B). In some embodiments, the main body 622 of the trunk cable retention member 620 includes a recess 623 which is configured to align with the securing flange 311′ of the gel block 300′ when the trunk cable retention member 620 is engaged with the gel block 300′. The recess 623 provides easy access by a technician to secure the fastener 25 (and gel block 300′) to the base member 510 of the OFDC 500.

As further shown in FIG. 20, in some embodiments, the main body 622 of the trunk cable retention member 620 further comprises one or more securing features 627, 628. In some embodiments, the one or more securing features 627, 628 are configured to engage and secure a respective grommet 620 or retention clip 321 to the trunk cable retention member 620 (see, e.g., FIG. 21 and FIGS. 22A-22B).

FIG. 21 and FIGS. 22A-22B illustrate the engagement of the trunk cable retention member 620 with the gel block 300′ according to embodiments of the present invention. In some embodiments, one or more of the securing features 624 may be sized and configured to be received by a respective opening 301′ in the main body 302′ of the gel block 300′ (see, e.g., FIG. 21 and FIG. 22B). In some embodiments, the securing feature 624 has an arcuate shape that corresponds to the profile of an inner surface of the respective opening 301′ in the main body 302′ of the gel block 300′ (see, e.g., FIG. 20). In some embodiments, then the fiber trunk cable 10 is routed through the opening 301′, the securing feature 624 engages the fiber trunk cable 10 to further secure the fiber trunk cable 10 within the opening 301′ of the gel block 300′ In some embodiments, cable ties or the like (not shown) may be used to hold the fiber trunk cable 10 in contact with the trunk cable retention member 620 as the fiber trunk cable 10 is routed into the interior cavity 515 of the OFDC 500.

As further shown in FIG. 21 and FIG. 22B, in some embodiments, one or more of the securing features 625 may be configured to engage with the main body 302′ of the gel block 300′. For example, in some embodiments, the securing features 625 may be configured to be received by a respective aperture 302a′ in the main body 302′ of the gel block 300′. In some embodiments, one or more of the securing features 626 may be configured to engage with a protrusion 308′ extending outwardly from the main body 302′ of the gel block 300′ (see, e.g., FIG. 21 and FIG. 22B).

FIG. 23 illustrates an exemplary configuration for the routing of cables 10, 20, 30 within the OFDC 500 using the adapter panel 600 according to embodiments of the present invention. As shown in FIG. 23, a fiber optic trunk cable 10 is routed through the gel block 300′ and into the interior cavity 515 of the OFDC 500. The trunk cable 10 is routed along the periphery of the interior cavity 515 and under the fiber optic connector adapters 400′ (i.e., the mounting section 614 of the base member 610) (see also, e.g., FIGS. 14A-14C). In some embodiments, the trunk cable 10 may be routed around the extension member 613 of the base member 610. Within the interior cavity 515 of the OFDC 500, fiber optic cables 30 are separated from the trunk cable 10 at transition 15 (i.e., “break out”). The excess or redundant length of the fiber optic breakout cables 30 may be wound around the arcuate members 642. The fiber optic breakout cables 30 may then be connected to respective ports 404′ of the fiber optic connector adapters 400′. Fiber optic jumper cables 20 are routed through respective slots 307′ in the gel block 300′ and into the interior cavity 515 of the OFDC 500. The fiber optic jumper cables 20 may then be connected to corresponding ports 404′ of the fiber optic connector adapters 400′ to complete the connections within the OFDC 500.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

1.-38. (canceled)

39. A fiber management system assembly, the assembly comprising:
a closure including a base member and a cover which together define an interior cavity, wherein the base member and cover are configured to be secured together in a closed and locked position via one or more locking features; and
an adapter panel, the adapter panel comprising:
a base member configured to be secured to the base member of the closure;
a trunk cable retention member configured to engage a gel block within the interior cavity of the closure; and
one or more fiber connector adapter members configured to secure a plurality of fiber optic connector adapters within interior cavity of the closure.

40.-41. (canceled)

42. The assembly according to claim 39, wherein the base member of the adapter panel comprises one or more snap-fit securing type mechanisms configured to secure the base member to the base member of the closure.

43. The assembly according to claim 39, wherein the base member of the adapter panel comprises:
a generally planar main body; and
a mounting section coupled to the main body, the mounting section configured to secure the one or more fiber optic connector adapter members within the closure.

44.-46. (canceled)

47. The assembly according to claim 43, wherein the base member further comprises one or more extension members configured to position the mounting section on a first plane that extends above and is parallel relative to a second plane of the main body of the base member.

48. The assembly according to claim 39, wherein each of the one or more fiber connector adapter members have a main body and a connector section extending upwardly from the main body, the connector section has a plurality of interior walls that divide the connector section into a plurality of channels, each of the channels is configured to receive and secure a respective fiber optic connector adapter therein.

49. The assembly according to claim 48, wherein a portion of the main body of each fiber connector adapter member is tapered, the tapered portion of the main body configured to position the plurality of fiber optic connector adapters at an upward angle to provide easier access to the plurality of fiber optic connectors adapters residing within the closure.

50. (canceled)

51. The assembly according to claim 48, wherein each fiber connector adapter member comprises one or more securing features extending from a bottom edge of the main body, the one or more securing features configured to engage with a corresponding aperture in the mounting section of the base member to secure the fiber connector adapter member thereto.

52. The assembly according to claim 48, wherein the connector section of each fiber connector adapter member comprises one or more additional securing features residing on an exterior surface of the connector section, the one or more additional securing features configured to engage with a corresponding securing feature for a stacking adapter.

53. The assembly according to claim 39, wherein the adapter panel further comprises one or more stacking adapters that are each configured to engage a respective fiber connector adapter member, the one or more stacking adapters configured to secure and hold additional fiber optic connector adapters within the closure.

54. The assembly according to claim 53, wherein each stacking adapter has a main body having a plurality of interior walls that divide the main body into a plurality of channels, each channel configured to receive and secure a respective fiber optic connector adapter therein, and each stacking adapter comprises a pair of securing features extending downwardly from opposing ends of the main body, the securing features configured to engage with a corresponding securing feature on an exterior surface of the connector section of the fiber connector adapter member.

55. (canceled)

56. The assembly according to claim 39, wherein the trunk cable retention member has a main body configured to engage with the gel block and provide support to a trunk cables routed into the interior cavity of the closure through the gel block.

57.-58. (canceled)

59. An adapter panel for a fiber management system, the adapter panel comprising:
a base member configured to be secured to a base member of an outdoor fiber distribution closure, the base member comprising a generally planar main body, and a mounting section coupled to the main body;
a trunk cable retention member having a main body configured to engage with a gel block within an interior cavity of the outdoor fiber distribution closure; and
one or more fiber connector adapter members secured to the mounting section of the base member, wherein each of the one or more fiber connector adapter has a main body and a connector section extending upwardly from the main body, the connector section has a plurality of interior walls that divide the connector section into a plurality of channels, and each of the channels is configured to receive and secure a respective fiber optic connector adapter therein.

60. The adapter panel according to claim 59, wherein the base member of the adapter panel comprises one or more snap-fit securing type mechanisms configured to secure the base member to the base member of the outdoor fiber distribution closure.

61.-62 (canceled)

63. The adapter panel according to claim 59, wherein the mounting section has one or more apertures that are each configured to receive a respective securing feature of the one or more fiber connector adapter members to secure the respective fiber connector adapter member to the mounting section.

64. The adapter panel according to claim 59, wherein the base member of the adapter panel further comprises one or more extension members configured to position the mounting section on a first plane that extends above and is parallel relative to a second plane of the main body of the base member of the adapter panel.

65. The adapter panel according to claim 59, wherein a portion of the main body of each fiber connector adapter member is tapered, the tapered portion of the main body configured to position the plurality of fiber optic connector adapters at an upward angle to provide easier access to the plurality of fiber optic connectors adapters residing within the closure.

66.-68. (canceled)

69. The adapter panel according to claim 59, further comprising one or more stacking adapters that are each configured to engage a respective fiber connector adapter member, the one or more stacking adapters configured to secure and hold additional fiber optic connector adapters within the closure.

70. The adapter panel according to claim 69, wherein each stacking adapter has a main body having a plurality of interior walls that divide the main body into a plurality of channels, each channel configured to receive and secure a respective fiber optic connector adapter therein, and wherein each stacking adapter comprises a pair of securing features extending downwardly from opposing ends of the main body, the securing features configured to engage with a corresponding securing feature on an exterior surface of the connector section of the fiber connector adapter member.

71. (canceled)

72. The adapter panel according to claim 59, wherein the main body of the trunk cable retention member comprises one or more engagement mechanisms that are configured to engage and secure the trunk cable retention member to the gel block.

73. (canceled)

74. A fiber management system assembly, the assembly comprising:
a closure including a base member and a cover which together define an interior cavity, wherein the base member and cover are configured to be secured together in a closed and locked position via one or more locking features; and
an adapter panel, the adapter panel comprising:
a base member configured to be secured to the base member of the closure;
a trunk cable retention member configured to engage a gel block within the interior cavity of the closure; and
one or more fiber connector adapter members, each fiber connector adapter member having a plurality of interior walls that divide the member into a plurality of channels, each channel configured to receive and secure a respective fiber optic connector adapter therein, wherein a portion of each fiber connector adapter member is tapered, the tapered portion is configured to position the plurality of fiber optic connector adapters at an upward angle, thereby providing easier access to the plurality of fiber optic connectors adapters within the closure.
